(19) United States
(12) Patent Application Publication
(10) Pub. No.: US 2006/0144469 A1
(43) Pub. Date: Jul. 6, 2006

(54) Waste exhausing device for a planing machine

(76) Inventor: Bor-Yann Chuang, Taiping Shiang (TW)

Correspondence Address: TROXELL LAW OFFICE PLLC;SUITE 1404, 5205 LEESBURG PIKE, FALLS CHURCH, VA, 22041, US

(21) Appl. No.: 11/024,647

(22) Filed: Dec. 30, 2004

(51) Int. Cl. B27C 1/00; B27G 21/00; B27G 19/00

(52) U.S. Cl. 144/252.1; 144/117.1

(57) ABSTRACT

A waste exhausting device for a planing machine includes a blower fixed above a knife shaft fixed in a machine base, a first friction wheel at a first end of a belt wheel of the knife shaft, a second friction wheel and an idle wheel positioned at a same side of the machine base. The second friction wheel has a same shaft with a turbine blade arranged in the blower, and the turbine blade is indirectly rotated by the knife shaft via the second friction wheel, the idle wheel and the first friction wheel for blowing out or exhausting wood waste produced by the knife on the knife shaft. So the blower and the knife shaft are operated by the same motor.

### BACKGROUND OF THE INVENTION

1. Field of the Invention

This inventin relates to a planing machine, particularly to one provided with a waste exhausting device sharing a common motor for rotating a knife shaft and for a turbine blade in a blower of the waste exhausting device to simplify the structure of the planing machine to enable the knife shaft and the blower synchronously operated or stopped together to reduce the cost of the planing machine.

2. Description of the Prior Art

A conventional planing machine is mostly provided with a blower driven by a motor for blowing or exhausting out wood waste produced in its operation, preventing the workplace from getting dirty by wood waste floating around and keeping workers' good health. But the knife shaft and the blower use a separate motor to have its structure rather complicated and subsequently its cost has to become higher. Moreover, two motors may consume more electricity.

### SUMMARY OF THE INVENTION

This invention offers a waste exhausting device for a planing machine, which includes a blower above a knife shaft deposited on a machine base, a first friction wheel fixed on one end of a belt wheel located at one side of the machine base, a second friction wheel and an idle wheel positioned at the same side of the machine base. The second friction wheel is fixed on the same shaft of a turbine blades, so the blower may be operated by the first friction wheel, the idle wheel and the second friction wheel mutually contacting with one another, thus synchronously operating and stopping together with the knife shaft, automatically exhausting wood waste, using only one motor and less components needed,

### BRIEF DESCRIPTION OF DRAWINGS

This invention will be better understood by referring to the accompanying drawings, wherein:

FIG. 1 is a partial perspective view of a planing machine provided with a waste-exhausting device in the present invention;

FIG. 2 is an exploded perspective view of the planing machine in the present inventin;

FIG. 3 is an exploded perspective view of a blower in the present invention;

FIG. 4 is a side view of the waste exhausting device in the present invention, showing its transmitting condition; and,

FIG. 5 is a side cross-sectional view of the waste-exhausting device in the present invention, showing it in a waste-exhausting condition.

### DETAILED DESCRIPTION OF THE PREFERRED EMODIMENT

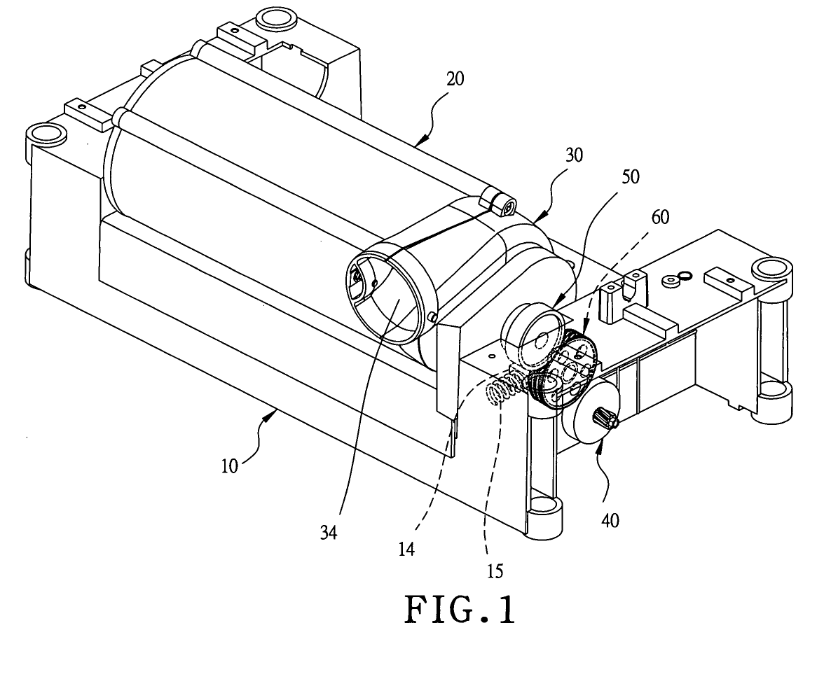

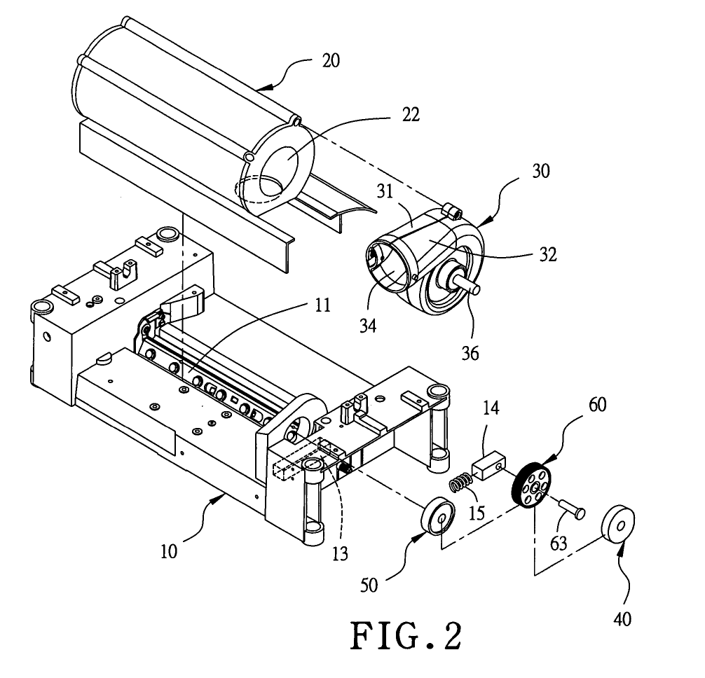

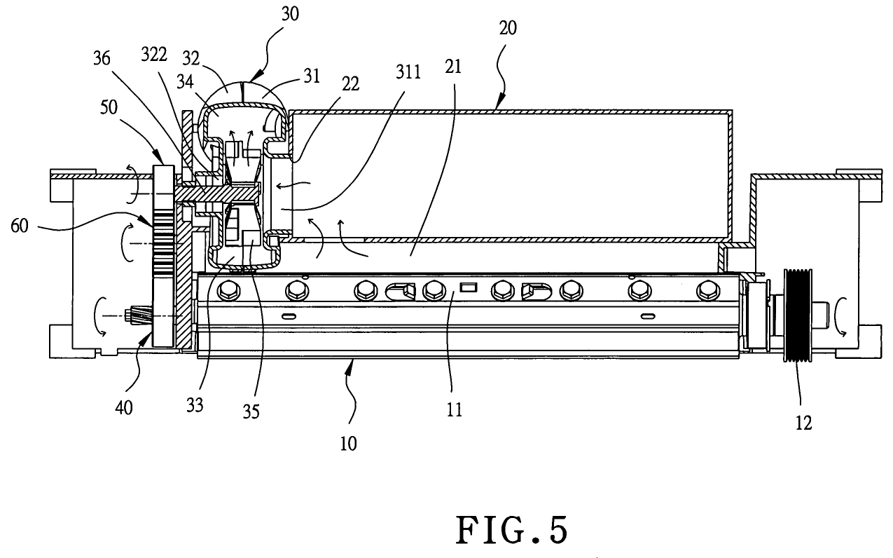

A preferred embodiment of a waste exhausting device for a planing machine in the present invention, as shown in FIGS. 1, 2 and 5, includes a wind cover 20, a blower 30, a first friction wheel 40, a second friction wheel 50, and an idle wheel 60 as main components combined on a machine base 10 of a planing machine.

The machine base 10 has a knife shaft 11 fixed thereon, and a belt wheel 12 fixed at one end of the knife shaft 11 and driven by a motor (not shown). The machine base 10 further has a lateral chamber 13 formed in an outer wall of the other side where the belt wheel is located, a shaft base 14 contained in the lateral chamber 13, a compress spring 15 also contained in the lateral chamber and having one end resting on an end surface of the shaft base 14 to elastically pushing the shaft base 14, and a wall hole 16 formed in an outer wall.

The wind cover 20 is fixed on the knife shaft 11, a wind-exhausting chamber 21 formed between the wind cover 20 and the machine base 10, and a wind hole 22 formed in one side of the wind cover 20 and communicating with the wind chamber 21.

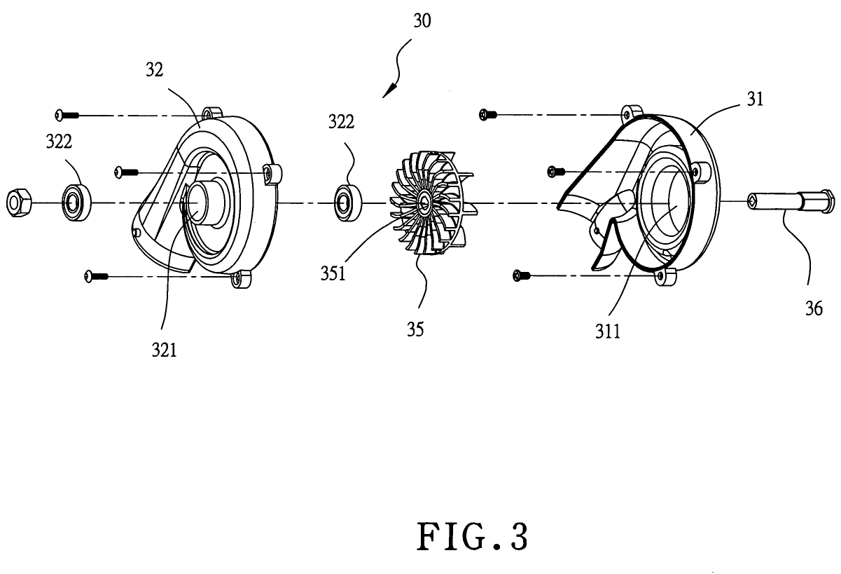

As shown in FIG. 3, the blower 30 consists of an inner half shell 31, an outer half shell 32, an interior space 33 defined by the outer half and the inner half shell 31 and 32 combined tightly together, a wind outlet 34 formed at the end of the combined inner and outer half shell 31 and 32, and a wind inlet 311 bored in the wall of the inner half shell 31 and communicating with the interior space 33. Further, the outer half shell 32 is provided with a center hole 321, and the inner half shell 31 is firmly connected with the wind cover 20, with the wind inlet 311 communicating with the wind hole 22. A turbine blade 35 is fitted in the interior space 33, having a center hole 351, with a rotatable shaft 36 fitting through the center hole 351, and with two bearings 322 fitted in the center hole 321 of the outer half shell 32 and the wall hole 16 of the machine base 10.

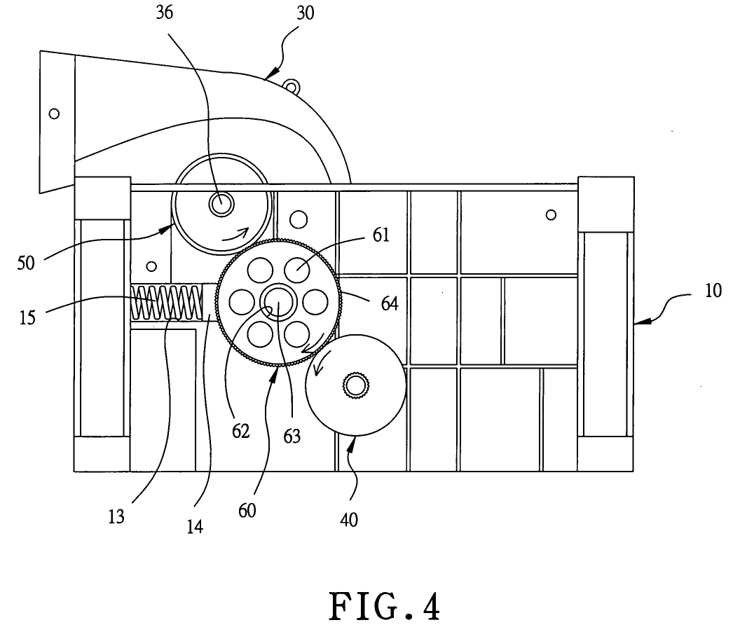

The first friction wheel 40, as shown in FIG. 4, is made of resisting-wear plastic steel, connected to the knife shaft 11 at the end where the belt wheel 12 is located, possible to be rotated by the knife shaft 11.

The second friction wheel 50 is also made of plastic steel, fixed with the rotatable shaft 36 for rotating the turbine blade 35 in the blower 30.

The idle wheel 60 is made of a metal, having a plurality of holes 61 in its wall arranged in a circle for dispersing heat, and a center hole 62 for an end of a spindle 63 to be fixed firmly in the center hole 61, and the other end of the spindle 63 fixed with the shaft base 14, so the idle wheel 60 is positioned between the first and the second friction wheel 40 and 50 for transmitting rotary power, having numerous teeth around its spherical surface for upgrading frictional force against the first and the second friction wheel 40 and 50.

Next, the operation of the waste-exhausting device in the invention is to be described. When the power (not shown) of the motor of the planing machine is transmitted by the belt to the belt wheel 12 at one end of the knife wheel 11 on the machine base 10, the knife wheel 11 begins to operate to plane woodwork. At this time, the first friction wheel 40 is rotated synchronously at the other end of the knife shaft 11, and then transmitted to the second friction wheel 50 via the idle wheel 60. Therefore, the rotatable shaft 36 of the turbine blade 35 is rotated by the second friction wheel 50, and producing wind in the interior space surrounded by the two half shells 31 and 32 to result in vacuum sucking force at the wind inlet 311 of the inner half shell 31. So wood waste produced by the knife shaft 11 may be sucked through the wind hole 22 of the wind cover 20 into the wind inlet 311 and then pass through the wind outlet 34 into an exhausting route (not shown) to be collected. In this way, the wood waste is exhausted out.

Then its has to be mentioned that the blower 30 in the invention has the first friction wheel 40, the second friction wheel 50 and the idle wheel 60 for transmitting rotation power from the knife shaft 11, so when the knife shaft 11 is driven by the motor for carrying out planing, the blower 30 is also moved synchronously, without handling any switch for operation or stopping of the blower 30. In other words, whenever the knife shaft 11 begins planing operation, waste-exhausting function is automatically started and also stopped in case of the knife shaft 11 stopped. So its handling is very convenient, and in addition, the blower 30 shares the same motor used for the knife shaft 11, possible to simplify the structure of the machine base 10, saving the cost for one motor, and obtaining economic gain.

While the preferred embodiment of the invention has been described above, it will be recognized and understood that various modifications may be made therein and the appended claims are intended to cover all such modifications that may fall within the spirit and scope of the invention.

What is claimed is:

1. A waste exhausting device for a planing machine, said planing machine having a machine base, a knife shaft installed in said machine base, said knife shaft having a first end fixed with a belt wheel driven by a motor, said waste exhausting device comprising:
A blower fixed at a proper location on said knife shaft:
A first friction wheel fixed at a second end of said knife shaft and rotated by said knife shaft:
A second friction wheel fixed at one side of said machine base and connected to a same shaft of a blade deposited in said blower so as to let said second friction wheel rotate said blade:
An idle wheel properly fixed at one side of said machine base and having its annular circumferential surface contacting firmly respectively with the outer circumferential surface of said first friction wheel and said second friction wheel for transmitting rotation force, said blower producing wood waste sucking force by means of rotation of said first friction wheel, said idle wheel and said second friction wheel, said blower operated by the same motor as said knife shaft is.

2. The waste exhausting device for a planing machine as claimed in claim 1, wherein a wind cover is provided on said knife shaft fixed on said machine base, said wind cover forms a wind chamber between said machine base, said wind cover has a wind hole in one side, said blower is located to face to said wind hole of said wind cover for exhausting wood waste into said wind chamber.

3. The waste exhausting device for a planing machine as claimed in claim 1, wherein said blower has an inner half shell and an outer half, said inner and said outer half shell are combined together to form an interior space and an wind outlet, said inner half shell having a wind inlet in its wall to communicate with said interior space, said outer half shell having a hole in its wall, said inner half shell connected properly with said wind cover, said wind inlet communicating with said wind hole, said blade shaped like a turbine and arranged in said interior space of said two half shells combined, said turbine blade having a center shaft hole, a spindle fitting through said center shaft hole, said spindle having its other end fixed with the shaft of said second friction wheel after extending through said center hole of said outer half shell.

4. The waste exhausting device for a planing machine as claimed in claim 1, wherein said machine base has a movable shaft base at a preset side, said movable base is fixed with the shaft of said idle wheel, a compress spring is provided and has one end contacting with said shaft base, and the other end resting on said machine base, said idle wheel kept in elastic contact with said first and said second friction wheel.

5. The waste exhausting device for a planing machine as claimed in claim 1, wherein said first and said second friction wheel are made of wear-resisting plastic steel.

6. The waste exhausting device for a planing machine as claimed in claim 1, wherein said idle wheel is provided with numerous teeth on its annular circumferential surface for reinforcing frictional force against said first and said second frictional wheel.

7. The waste exhausting device for a planing machine as claimed in claim 1, wherein said idle wheel is made of a metal, and provided with a plurality of holes spaced apart in its wall for dispersing heat.
